(19) United States
(12) Patent Application Publication
(10) Pub. No.: US 2007/0094183 A1
(43) Pub. Date: Apr. 26, 2007

(54) Jargon-based modeling

(75) Inventors: Timothy S. Paek, Sammamish, WA (US); Raman Chandrasekar, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/186,269

(22) Filed: Jul. 21, 2005

(51) Int. Cl. G06N 5/00

(52) U.S. Cl. 706/45

(57) ABSTRACT

An expertise model based upon jargon usage is described. The expertise model is generated by an expertise model training system which includes a feature extractor to extract jargon-based features from a training text corpus. A model training component uses the features to generate the expertise model. The expertise model can be used for varied applications such as providing help resources in response to a user help inquiry or ranking or re-ranking query results.

### BACKGROUND

People currently use computers for many different tasks. One common task is related to information retrieval in which a user poses a query to a search engine or help system to obtain desired information. In many cases, the user needs to search for information where the level of expertise the user possesses in particular domains affects the user's satisfaction with the returned results. However, people have different experience levels or levels of expertise in different domains. For example, computer users have a wide variety of knowledge in domains such as computers, medicine, or legal professions among others.

This can present problems in retrieving information relevant to a user's query and other problems as well. For example, if the user is a novice in a particular domain and the computer returns complex or advanced material in response to a query that was not intended to be complicated, the user will be confused. Similarly, if the user has a high degree of expertise and the information returned is rudimentary, the user may become frustrated.

In addition, less experienced people may find it difficult to use appropriate domain-specific language and formulate questions outside of their area of expertise. This is due in part to the non-expert's lack of familiarity with domain-specific technical terms (or jargon) and the proper use of this jargon. A user's lack of knowledge of jargon or domain-specific vocabulary can frustrate information retrieval because of mismatches between the non-experienced user's query expression and the language used or expressed in expert documents or publications.

Ascertaining a user's level of expertise in a particular domain or area is generally difficult. This has conventionally been done using subjective assessments, such as questionnaires. Relying on a user's own assessment of expertise may not be accurate since people often misrepresent their level of expertise or can overlook an area of expertise they may have forgotten.

The discussion above is merely provided as general background information and is not intended to be used as an aid in determining the scope of the claimed subject matter.

### SUMMARY

A system and model is used to determine a level of a user's expertise in a particular domain. In the embodiments described, the expertise model is generated by extracting jargon-based features from a training text corpus. A model training component uses the extracted features to generate the expertise model. The expertise model can be used for varied applications such as determining a user's level of expertise in association with providing help resources in response to a user help inquiry, ordering or re-ranking query results for information retrieval, or identifying subject matter experts, among other applications.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

### BRIEF DESCRIPTION OF THE DRAWINGS

FIG. 1 is a block diagram of one illustrative environment in which the present invention can be used.

FIG. 2 is a block diagram of one illustrative embodiment of an expertise model generation system.

FIG. 3 is a flow chart illustrating an illustrative embodiment for generating an expertise model.

FIG. 4 is a flow chart of an illustrative embodiment for generating an expertise model using jargon-based features.

FIG. 5 is a block diagram of a system for determining expertise based upon an expertise model.

FIG. 6 is a flow chart of an illustrative embodiment including steps for determining expertise.

### DETAILED DESCRIPTION

The present application relates to user modeling. Prior to describing it in great detail one embodiment of an environment in which it can be used will be described.

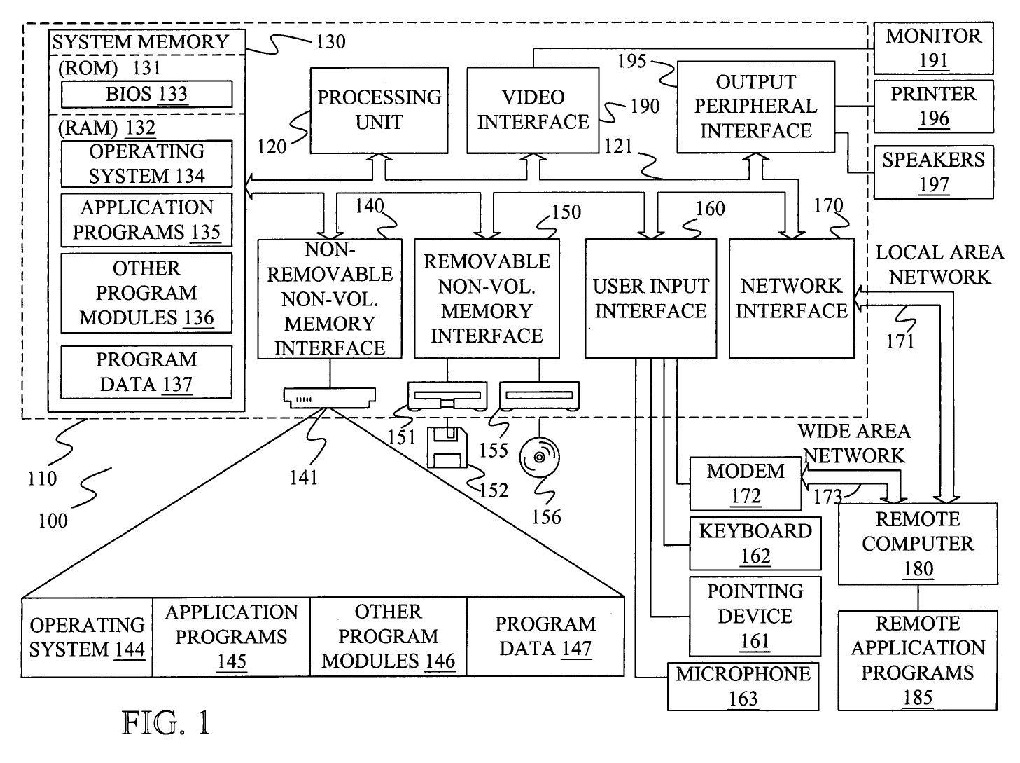

The computing system environment 100 shown in FIG. 1 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement aspects of the present invention as instructions stored on computer readable media based on the description and figures provided herein.

The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

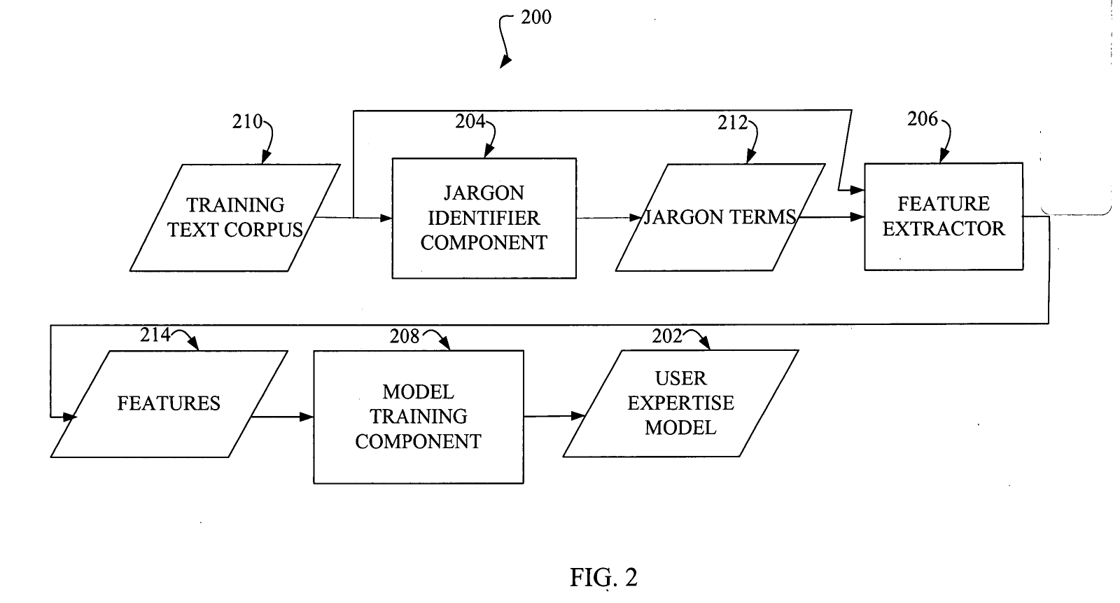

FIG. 2 illustrates an embodiment of an expertise model generation system 200 that generates user expertise model 202 used in ascertaining a level of expertise of a user in a particular domain or field. System 200 includes jargon identifier component 204, feature extractor 206 and model training component 208.

System 200 uses a training text corpus 210 for model generation. The training text corpus 210 for example, can include domain specific reference texts, documents, publications and/or natural language queries. For instance, in the computer domain, corpus 210 might include books, computer manuals, help screens for one or more operating systems, text generated at experts' websites, newsgroups, queries to experts or help systems or any other input text that has a labeled or ascertainable expertise level. Labels may be obtained through human transcription, automatic transcription, or may be inherent in the text itself, such as the organizational structure of the text (e.g., Table of Contents).

In the embodiment shown, the expertise model is generated based upon jargon-based features. Therefore, training text corpus 210 is provided to jargon identifier component 204 that extracts jargon terms 212 from the training text corpus 210. The jargon terms 212 and training text or corpus 210 are provided to the feature extractor 206 to extract jargon-based features 214. The jargon based features 214 are provided to model training component 208 to generate or train the user expertise model 202, which can be used to determine a level of user expertise based on a textual input.

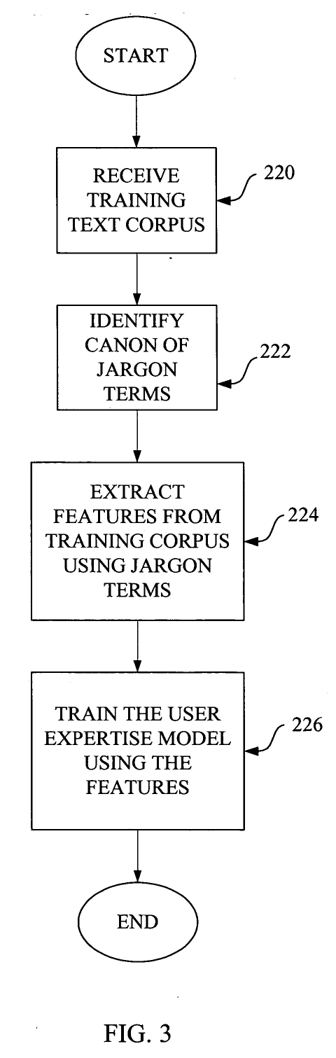

FIG. 3 is a flow diagram illustrating an embodiment of operation of the model generation system shown in FIG. 2 in more detail. As illustrated in step 220 of FIG. 3, the training text corpus 210 is received by jargon identifier component 204. In the illustrated embodiment, the training text corpus 210 can include both expert text which tells the model how jargon should be used as well as comparative text which includes both expert and non-expert usage of jargon. In one example for a computer domain, the expert text or canonical corpus includes text from help documents written for an operating system and a help system and help documents for applications that run on that operating system. The expert text can also include computer training manuals and other books used to provide a baseline training text corpus or canonical corpus.

In an illustrative example, the comparative text includes natural language queries which can be collected or amassed from postings of domain specific newsgroups. In a computer domain embodiment, natural language queries can be collected from newsgroup postings relating to operating systems help and support.

The postings can be selected to provide both novice and expert queries. For instance, the postings are categorized relative to experts vs. non-experts to facilitate comparison between an expert's use of jargon and a novice person's use of jargon. The expert's text in the posting serves the same function as the canonical text to provide a comparison relative to proper or expert jargon usage.

Experts or expert postings can be distinguished based upon an expert designation known in the industry (such as Most Valued Professionals (MVP) in the computer industry). Some experts can be identified based upon a known designation in their e-mail address. Postings can also be categorized based upon first-in-thread vs. non-first-in-thread. First-in-thread refers to the initial query thread and the non-first-in-thread refers to a reply or response to the first-in-thread. Novice users tend to initiate query threads and expert users tend to respond. Postings can be categorized based upon queries vs. solutions. Queries and solutions can be segregated based upon phrases in the queries such as “How do you . . . ?” or “Have you tried . . . ?”

As indicated by block 222 in FIG. 3, jargon identifier component 204 identifies a canon of jargon terms 212 in the training text corpus 210. This is indicated by block 222. Jargon terms 212 include for example, but are not limited to, domain-specific terminology or idioms used by people or experts in a particular field or domain and can include domain-specific acronyms. In one embodiment, the canon of jargon terms is compiled from the corpus 210 of expert language or text using the glossaries and indices of the corpus publications and documents.

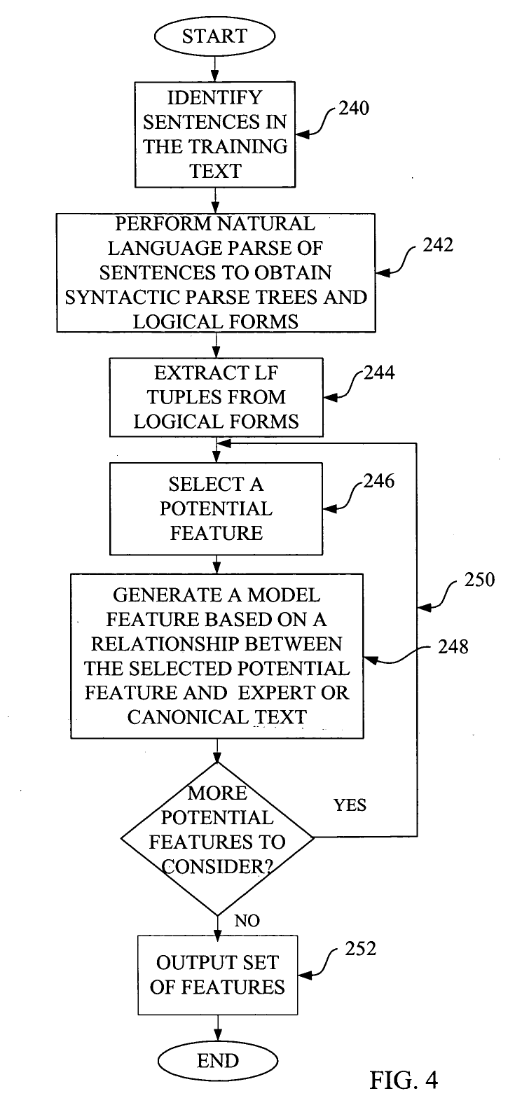

Features 214 extracted from the postings and canonical text are provided to the model training component 208 along with a categorization of expertise to generate the expertise model 202. The particular features extracted by extractor 206 can vary widely, and one embodiment is described in greater detail below with respect to FIG. 4. Once the features are extracted, model training component 208 uses the features to train model 202. The expertise model 202 is trained using conventional model training techniques or classifiers such as Naive Bayes or “Support Vector Machine” (SVM) based upon the extracted features.

As mentioned, the particular features extracted by feature extractor 206 can vary widely. In one embodiment feature extractor 206 extracts features relating to the semantic relation of the jargon terms relative to other words in the natural language input or training corpus 210. To extract semantic based features, the syntactical structure of the natural language input is analyzed. FIG. 4 illustrates an embodiment for extracting features based upon semantic structure of the training text 210.

As shown in step 240, sentences are identified in the training text corpus 210. A natural language parse of the identified sentences is performed to obtain syntactic parse trees and logical forms as illustrated by step 242. An example embodiment of a natural language parser to form syntactic trees and logical forms from an input sentence in training text corpus 210 represents a predicate-argument relation in a semantic graph, although application is not limited to a particular parser. Generating logical forms can be done in any desired way such as that set out in U.S. Pat. No. 5,966,686 entitled “Method and System for Computing Semantic Logical Forms From Syntax Trees”.

Once the logical form is generated for the input training sentences, n-tuples (such as triples) are extracted which contain the jargon terms. This is indicated by step 244. In an illustrated example, logical form triples are extracted in the structure <object1, relation, object2>, where the relations are represented by labels on the arc in the logical form and either object1 or object2 is the jargon term.

A feature is selected as illustrated by step 246 for the input training text or query 210. For example, a feature such as (*,Tobj, jargon term) is selected based upon the n-tuples or triples for the input text or query. For the selected feature, a model feature is generated based upon a relationship of the extracted tuple or triple relative to expert or canonical text. This is illustrated in step 248.

The model feature is generated in a wide variety of ways. For instance, a comparative feature may be generated based on whether the expert text includes the selected jargon based feature. For example, for the input text “run the Internet”, the fact that the selected jargon based feature is not found in the canonical corpus becomes a comparative feature. In another embodiment, the feature includes a weight assigned based upon a distribution of the extracted tuple or triple or selected feature in the canonical corpus or expert text.

Alternatively, the weight can be assigned simply based on a frequency of occurrence of the matching tuple in the canonical corpus or expert text. The weight can also be assigned based on a source of the matching tuple. For example, a weight can be assigned based upon whether the matching tuple or jargon-based feature was derived from advanced topics or higher level publications directed to higher level expertise. Also, if the extracted tuple appears in Chapter 15 of a resource text rather than in Chapter 1, the weight assigned may reflect a more expert level, given that the resource text is ordered in the difficulty of the concepts discussed.

In any case, the feature is used by the model training component 208 to build the user expertise model 202.

Multiple features can be selected or generated for the input text or query as illustrated by line 250. For example, multiple features can be selected for different jargon terms and/or relations. Feature selection and processing continues until no more features need to be processed. If there are no more potential features, then a set of features is output as illustrated by step 252.

An example may help to illustrate this embodiment. Assume a training sentence is the query, “How do I run the Internet on operating system XYZ?”. The sentence is parsed to obtain syntactic parse trees and logical forms. In an example embodiment, the triple <run, Tobj, Internet> for the jargon term “Internet” is generated from the logical form for the sentence. Tobj is a “typical object” relation. The feature <*,Tobj, Internet> is selected and a weight is assigned to the extracted triple <run, Tobj, Internet> based upon the relationship of the extracted triple relative to the selected feature in the canonical corpus.

In other words, in the illustrated embodiment, the extracted triple <run, Tobj, Internet> is compared to the distribution of triples with the selected feature <*,Tobj, Internet> in the canonical corpus. In this example, for the selected feature <*,Tobj, Internet>, the word “access” is the most frequently occurring first object of that triple—e.g. it corresponds to “access the internet”. The triple <run, Tobj, Internet> does not appear at all. Hence in the illustrated example, a weight that reflects that <run, Tobj, Internet> does not appear in the training text or canonical corpus 210 is generated. In contrast if the triple does appear, its weight would reflect its occurrence with respect to other triples for the selected feature <*, Tobj, Internet>.

Of course, as discussed above, other features can be selected or the model features can be derived in other ways, such as use of a jargon term in a particular source or particular context. For example, if the query includes a jargon term that appears in a highly advanced or complex document, the training component 208 may assign a higher weight than if the jargon term appears in an elementary text. As discussed above, the model feature can be a differential feature that assesses differences between a canon feature and a comparative text feature. In the above-example, if the comparative text has a jargon-based feature—“run the Internet”, but the canon text does not have such an instance, then the fact that it does not have that instance is the model feature.

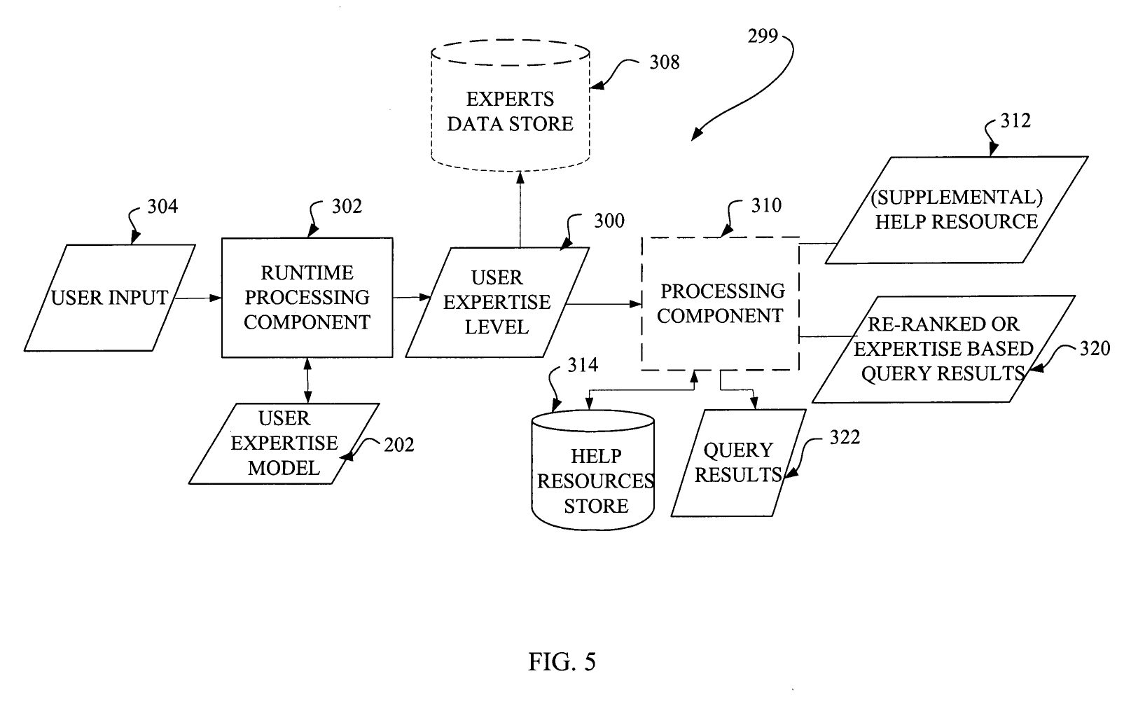

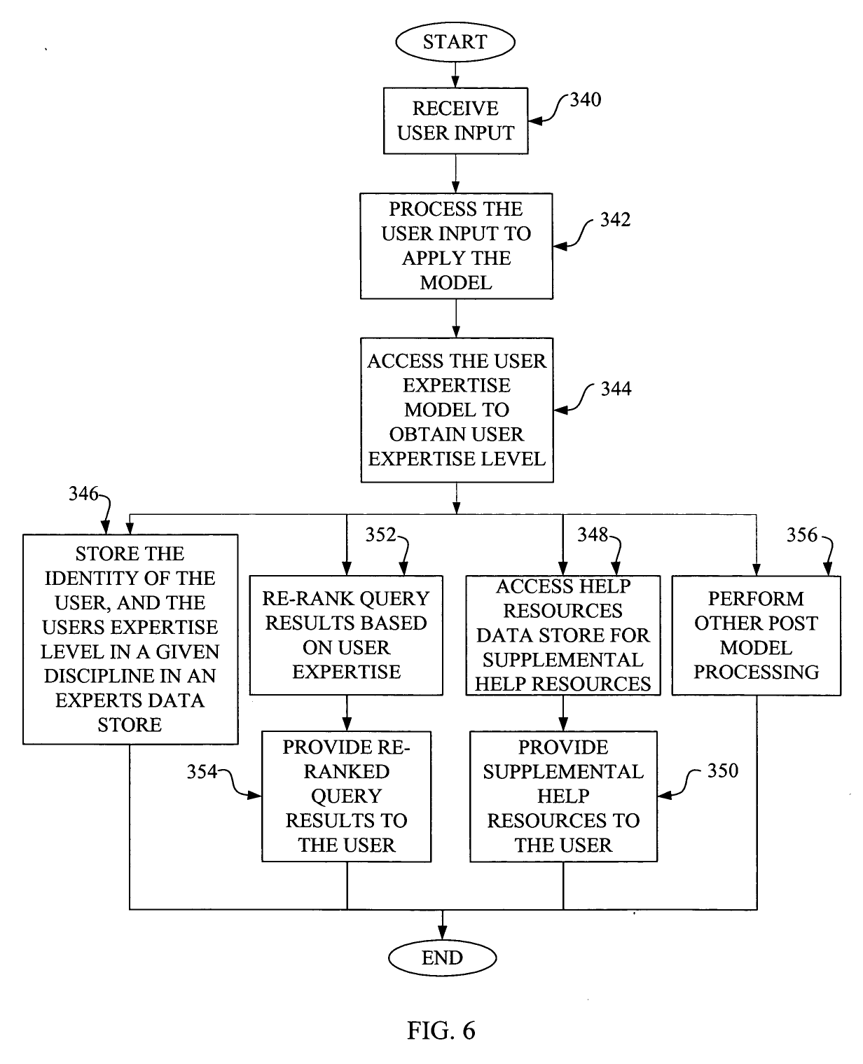

FIG. 5 illustrates one exemplary runtime environment 299 that uses the user expertise model 214 to determine a user expertise level 300. FIG. 6 is a flow diagram illustrating operation of system 299 in FIG. 5. As shown, a runtime processing component 302 receives a user input 304, for example—“How do I run the Internet on operating system XYZ?”. This is indicated by block 340 in FIG. 6. Component 302 processes the user input 304 so that the model 202 can be applied. This is indicated by block 342 in FIG. 6. For instance, where model 202 includes logical form triples, triples are generated for the user input 304.

Component 302 uses the user expertise model 202 to determine the user expertise level 300 based upon user input 304. This is illustrated in block 344 of FIG. 6. As shown in FIG. 5, the user expertise level 300 can simply be stored in an expert data store 308. This might be done for example to simply build a database of experts that can be accessed to build a team or find an expert in a given subject, etc. Storing the expertise level, for a given expert, in a given discipline, is indicated by block 346 in FIG. 6.

In another embodiment, expertise level 300 can be provided as input to a post processing component 310 for various applications.

In one embodiment, the processing component 310 uses the user's expertise level 300 to provide more appropriate or supplemental help support 312 from a help resource store 314 in response to the user input query 304. This allows a novice user to receive help that is directed at a level which the user can understand. Conversely, a more experienced user can receive resource information tailored to a more expert level. Accessing a help resources data store 314 and providing supplemental help resources 312 is shown in blocks 348 and 350.

In another embodiment, the post processing component 310 uses the user's expertise level 300 to order query results or search results 320 retrieved in response to the user input query 304. As shown in FIG. 5, the processing component 310 receives the query results 322 and user expertise level 300 and re-routes the query results and outputs the re-ranked query results 320. Re-ranking results 320 allows the component 310 to place the most appropriate results (based on the complexity of the results and the user's expertise level) at the top of the retained results. This is indicated in blocks 352 and 354 in FIG. 6.

Of course, other post processing can be performed as illustrated by block 356.

Another application uses a user expertise level to respond to a search query with an elaboration question, declarative answer or request for clarification. In particular in response to a search or help query, a search engine can provide not only a result list but also respond with an elaboration question or declarative answer. For instance for the question “What is cat”, or search term “cat” the search engine can request additional information or respond in the form of a question, such as “Did you mean animal CAT or the UNIX command CAT?”.

In the another application, the processing component uses the user's expertise level to provide an expertise based query response or request additional information in the form of a question as illustrated by block 320. For example, the processing component can use the user expertise level among other features to determine that the user is asking a technical question. Thus, based upon the user's expertise level in the computer domain, the system can respond to the user's question “What is CAT” with the result that “CAT stands for ‘concatentation’ and is used to append files”. Alternatively if the user does not have expertise in the computer domain, the system can respond by requesting additional information or requesting clarification such as, “Did you mean animal CAT or UNIX command CAT?”.

Application of the user expertise -model disclosed is not limited to the embodiments illustrated in FIGS. 5-6.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A user model, comprising:
an expertise model trained to receive an input and provide an indication of expertise in a given domain, indicated in the input.

2. The user model of claim 1 wherein the expertise model is configured to provide the indicator of expertise based on jargon-based features in the input.

3. The user model of claim 2 wherein the jargon-based features include semantic relations for jargon terms in the input.

4. The user model of claim 2 wherein the jargon-based features include use of jargon terms in the input in comparison to use of the jargon terms by others of a predetermined expertise.

5. An expertise model training system comprising:
a feature extractor configured to extract at least one jargon-based feature from a training text corpus; and
a model training component configured to train an expertise model, so the model provides an indication of expertise for an input, using the jargon based feature.

6. The expertise model training system of claim 5 and further comprising:
a jargon term identifier configured to identify jargon terms in the training text corpus.

7. The expertise model training system of claim 6 wherein the feature extractor is configured to extract the jargon-based feature from using the jargon terms identified.

8. The expertise model training system of claim 5 wherein the training text corpus includes text containing expert language.

9. The expertise model training system of claim 8 wherein the training text corpus includes comparative text and the feature extractor extracts features from the comparative text.

10. The expertise model training system of claim 5 wherein the feature extractor generates a comparative feature relating to differences between expert text and non-expert text.

11. The expertise model training system of claim 5 wherein the feature extractor extracts semantic relation structures for jargon terms in the training text corpus.

12. A method of processing for a user input based on expertise level, comprising:
receiving a natural language user input;
accessing a user expertise model to generate a user expertise level associated with the natural language user input based on identified jargon terms in the natural language user input.

13. The method of claim 12 and further comprising:
processing the natural language user input so the user expertise model can be applied.

14. The method of claim 12 wherein the natural language user input comprises a help query and further comprising:
using the expertise level to generate a response to the help query.

15. The method of claim 12 wherein the natural language user input comprises a search query and further comprising:
using the expertise level to rank results for the search query.

16. The method of claim 12 wherein the natural language user input comprises a search query and further comprising:
using the expertise level to respond with an elaboration question, a request for clarification or a declarative answer.

17. The method of claim 12 and further comprising:
storing the expertise level in a data store of experts with identified expertise levels.

18. The method of claim 12 and further comprising:
accessing a help resources data store based on the expertise level and suggesting supplemental help resources in response to the natural language user input.

19. The method of claim 13 wherein processing the natural language input comprises:
extracting from the natural language input, semantic relations that include the jargon terms.

20. The method of claim 19 wherein the semantic relations comprise logical forms.
